(19) United States
(12) Patent Application Publication
(10) Pub. No.: US 2023/0320814 A1
(43) Pub. Date: Oct. 12, 2023

(54) DYNAMICALLY DETERMINED SEQUENCE OF DENTAL-PROCEDURE OPERATIONS

(71) Applicant: Barndt Consulting, Old Lyme, CT (US)

(72) Inventor: Peter Barndt, Forest Hill, MD (US)

(73) Assignee: Barndt Consulting, Old Lyme, CT (US)

(21) Appl. No.: 18/185,914

(22) Filed: Mar. 17, 2023

Related U.S. Application Data
(60) Provisional application No. 63/321,089, filed on Mar. 17, 2022.

(51) Int. Cl. A61C 1/08; A61C 8/00

(52) U.S. Cl. CPC A61C 1/084; A61C 8/0089

(57) ABSTRACT

During operation, an electronic device may receive measurement information (such as a speed of insertion, a torque and/or a 3D position) associated with a handheld tool (such as a drill) during a dental procedure on an individual. Note that the measurements may be performed directly or may be inferred, such as based on power consumption of the drill as a function of time. Then, the electronic device may dynamically determine a sequence of operations for creating a dental osteotomy during the dental procedure based at least in part on the measurement information. Moreover, the electronic device may provide information associated with the determined sequence of operations, such as: a depth, a width and/or a shape of the dental osteotomy; a sequence of tools to use during the dental procedure; a speed of insertion of the drill; an implant design or shape to be placed; and/or a torque of the drill.

### CROSS-REFERENCE TO RELATED APPLICATIONS

This application claims priority to U.S. Provisional Pat. Application No. 63/321,089 filed on Mar. 17, 2022, which is incorporated herein by reference in its entirety.

### FIELD

The described embodiments relate to dynamically determining a sequence of operations in a dental procedure based at least in part on measurements performed using a handheld tool, such as a drill.

### BACKGROUND

During many surgical procedures, an orthopedic surgeon, an oral surgeon or a maxillofacial surgeon cuts or reshapes bone(s) using a surgical tool, such as a drill. For example, during a dental osteotomy, a hole is created in a patient’s jaw in order to place a dental implant. In order to achieve stability to support the successful healing of the implant to surrounding bone (which is referred to as ‘osseointegration’), the implant must have initial stability in the bone achieved through an interference fit between the osteotomy and the implant. The amount of interference fit determines how much resistance is encountered during the insertion of the implant. Moreover, the vast majority of dental implants contain a thread pattern on their external surface that functions to cut through bone and provide the necessary leverage to advance the implant into an undersized osteotomy.

However, the implant must achieve a specific, pre-planned vertical position in the bone, which makes managing of the interference fit more complicated. Notably, if the osteotomy is too large, adequate stability may not be achieved upon implant insertion. Alternatively, if the osteotomy is too small, torque levels to advance the implant to the desired depth may become excessive and fracture the implant or cause the threads to ‘strip’ the surrounding bone. In general, the variation of human bone composition (which is referred to as ‘bone quality’) makes the interference fit less predictable. Bone quality varies from extremely dense bone to spongy, low-density bone, and varies considerably between patients and even at different locations in the jawbone of a given patient.

The bone quality of a patient can determine how much interference fit would be indicated, and can also influence the choice of implant thread patterns and shape. Current surgical practices do not quantitatively measure bone quality of the patient either pre-operatively or intra-operatively. For example, is often difficult to determine bone quality from three-dimensional (3D) x-rays. Consequently, bone quality is subjectively evaluated by a surgeon intra-operatively following each drilling step to make decisions about the final interference fit. Surgical decisions can be made to ‘undersize’ the osteotomy for greater interference fit in lower quality bone, or to use a tap to apply threads to the osteotomy in very dense, high-quality bone. These choices greatly influence the final stability of the implant and the torque required to advance a threaded implant to its planned depth.

Note that the initial outcome of implant surgery is typically measured by the initial, or ‘primary’ stability of the implant. The final outcome is measured after a healing period (e.g., 6-16 weeks) and is defined by a rigid, non-moving implant able to support applied loads (via a prosthesis) from the patient. It is not uncommon for a surgeon to prepare and place an implant that fails to achieve primary stability. In response, the surgeon may immediately remove the implant, and may subsequently place a larger diameter implant for greater primary stability. Instead of aborting the surgery, this remediation sequence is a desperate effort to achieve a greater interference fit and the required stability. However, it is an expensive surgical solution, because the original, smaller implant placed must be discarded. The remediation sequence is also indicative of how challenging the qualitative management of the interference fit between osteotomy and implant can be.

Additionally, recent advances in implant treatment include creating a prosthesis prior to surgery. Then, at the time of surgical placement, the predefined prosthesis is attached to the implant. This surgical technique also requires excellent primary stability of the implant, so that the interference fit is great enough to prevent significant movement of the implant during healing from low-level loads applied by the patient. However, the limitations of existing surgical techniques often make it difficult for a dental osteotomy to optimize primary implant stability and patient outcomes.

### SUMMARY

In a first group of embodiments, an electronic device that provides information associated with a sequence of operations is described. This electronic device includes an interface circuit that communicates with a handheld tool. During operation, the electronic device receives measurement information associated with the handheld tool during a dental procedure on an individual. Then, the electronic device dynamically determines the sequence of operations for creating a dental osteotomy during the dental procedure based at least in part on the measurement information. Moreover, the electronic device provides the information.

Note that the handheld tool may include a type of drill. For example, the sequence of operations may include: a speed of insertion of a drill; a torque of the drill; an electric draw of the drill motor, a torque, and/or a rotational energy used to insert an implant into the dental osteotomy.

Moreover, the sequence of operations may include preparation of the dental osteotomy, such as: drilling into bone; and/or compressing the bone.

Furthermore, the measurement information may correspond to resistance of the individual’s bone to cutting and/or compressing operations during the dental procedure.

Additionally, the measurement information comprises a 3D position of the handheld tool. For example, the 3D position may be relative to oral anatomy of the individual or to a planned final position of the implant.

In some embodiments, the measurement information may correspond to power consumption as a function of time of the handheld tool during the dental procedure. For example, the measurement information may include: a torque of the handheld tool as a function of time; and/or an electrical current associated with the handheld tool as a function of time. Alternatively or additionally, the measurement information may correspond to a position of the handheld tool. This may allow resistance of the individual’s bone to be associated with a specific depth of the dental osteotomy. For example, a dense surface layer of the bone may be characterized based at least in part on the measurement information. Moreover, knowledge of where resistance was encountered in the shaping of the dental osteometry may allow the sequence of operations to be determined and/or the recommendation to be provided.

Note that the determined sequence of operations may include an output of a pretrained predictive model. For example, the pretrained predictive model may include: a neural network; and/or a supervised-learning model.

Moreover, the dental osteotomy may be associated with the implant.

Furthermore, the recommendation may include: a depth, a width, or a shape of the dental osteotomy. Additionally, the recommendation may include a sequence of tools to use during the dental procedure. In some embodiments, the recommendation may include: a sequence of drills or compressive shaping tools, a speed of rotation of the drill; a torque of the drill; and/or a torque used to insert an implant into the dental osteotomy.

Another embodiment provides the handheld tool.

Another embodiment provides a computer-readable storage medium for use with the electronic device or the handheld tool. When executed by the electronic device or the handheld tool, this computer-readable storage medium causes the electronic device or the handheld tool to perform at least some of the aforementioned operations or counterparts to at least some of the aforementioned operations.

Another embodiment provides a method, which may be performed by the electronic device or the handheld tool. This method includes at least some of the aforementioned operations or counterparts to at least some of the aforementioned operations.

In a second group of embodiments, a computer system that dynamically updates at least one predefined or predetermined sequence of operations in a set of predefined or predetermined sequences of operations is described. This computer system includes: an interface circuit that communicates with an electronic device; a computation device coupled to the interface circuit; and memory, coupled to the computation device, storing program instructions, where, when executed by the computation device, the program instructions cause the computer system to perform operations. Notably, during operation, the computer system accesses at least the one of the predefined or predetermined sequence of operations based at least in part on pre-operative factors, such as: an anatomical location of an instance of a type of dental procedure (and, more generally, information associated with an individual), 3D imaging and/or a preference of a surgeon. Note that the set of predefined or predetermined sequences of operations is based at least in part on prior measurement results collected during historical instances of the type of dental procedure performed on multiple individuals and prior outcome metrics of the historical instances of the type of dental procedure. Then, the computer system provides procedure information associated with at least the one of the predefined or predetermined sequence of operations addressed to the electronic device, and receives feedback associated with the electronic device. The feedback includes resistance information about resistance of bone during the instance of the type of dental procedure, which predicts stability of an implant after the instance of the type of dental procedure. Based at least in part on the feedback, the computer system dynamically updates at least the one of the predefined or predetermined sequence of operations, and provides an intra-operative recommendation based at least in part on at least the one predefined or predetermined sequence of operations to the surgeon for optimal implant primary stability.

Note that the type of dental procedure may include creating a dental osteotomy. Moreover, the recommendation may include: a depth of the dental osteotomy and/or a width of the dental osteotomy. Furthermore, the recommendation may include a sequence of tools to use during the instance of the type of dental procedure. Additionally, the recommendation may include: a speed of insertion of a drill; a torque of the drill; and/or a torque or rotational energy (corresponding to a product of the torque and rotation) used to insert the implant into the dental osteotomy.

In some embodiments, the feedback may include: a first change to the shape of the implant when the instance of the type of dental procedure was performed; and/or a second change to the sequence of operations when the instance of the type of dental procedure was performed. Moreover, the update to at least the one of the predefined or predetermined sequences of operation may be predicted to reduce a size of the first change, and/or a size of the second change associated with another instance of the type of dental procedure.

Furthermore, the information associated with the individual may include 2D and/or 3D x-ray information associated with oral anatomy of the individual. Additionally, the information associated with the individual may include a measured current shape of a tooth and a target shape of the tooth.

Note that the stability may correspond to: a peak torque of a handheld tool that was used when the instance of the type of dental procedure was performed; rotational energy used to deliver the implant to a planned position; and/or stability information associated with vibration of the implant after the instance of the type of dental procedure was performed.

In some embodiments, a given outcome metric was determined within 1 hr. of completion of a given historical instance of the type of surgical procedure. Alternatively or additionally, a given outcome metric was determined more than six months after completion of a given historical instance of the type of surgical procedure.

Moreover, in some embodiments, instead of or in addition to updating at least the one predefined or predetermined sequence of operations, the computer system updates a pretrained predictive model (which may provide the recommendation), such as: a neural network; and/or a supervised-learning model.

Another embodiment provides the handheld tool.

Another embodiment provides the electronic device.

Another embodiment provides a computer-readable storage medium for use with the computer system, electronic device or the handheld tool. When executed by the computer system, the electronic device or the handheld tool, this computer-readable storage medium causes the computer system, the electronic device or the handheld tool to perform at least some of the aforementioned operations or counterparts to at least some of the aforementioned operations.

Another embodiment provides a method, which may be performed by the computer system, the electronic device or the handheld tool. This method includes at least some of the aforementioned operations or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a handheld tool, an electronic device and a computer system in accordance with an embodiment of the present disclosure.

FIG. 2 is a flow diagram illustrating an example of a method for providing information using an electronic device in FIG. 1 in accordance with an embodiment of the present disclosure.

FIG. 3 is a drawing illustrating an example of communication between a handheld tool and an electronic device in FIG. 1 in accordance with an embodiment of the present disclosure.

FIG. 4 is a drawing illustrating an example of an implant in a dental osteotomy in accordance with an embodiment of the present disclosure.

FIG. 5 is a drawing illustrating an example of a method for providing information using an electronic device in FIG. 1 in accordance with an embodiment of the present disclosure.

FIG. 6 is a flow diagram illustrating an example of a method for dynamically updating at least one predefined or predetermined sequence of operations using a computer system in FIG. 1 in accordance with an embodiment of the present disclosure.

FIG. 7 is a drawing illustrating an example of communication between an electronic device and a computer system in FIG. 1 in accordance with an embodiment of the present disclosure.

FIG. 8 is a drawing illustrating an example of a cross-section of human bone.

FIG. 9 is a drawing illustrating an examples of a sequence of operations in a dental osteotomy in accordance with an embodiment of the present disclosure.

FIG. 10 is a drawing illustrating examples of different types of drills and an implant in accordance with an embodiment of the present disclosure.

FIG. 11 is a drawing illustrating an example of a method for providing information using an electronic device in FIG. 1 in accordance with an embodiment of the present disclosure.

FIG. 12 is a drawing illustrating an example of a method for providing information using an electronic device in FIG. 1 in accordance with an embodiment of the present disclosure.

FIG. 13 is a drawing illustrating an example of a sequence of operations in a dental osteotomy in accordance with an embodiment of the present disclosure.

FIG. 14 is a drawing illustrating examples of sequences of operations in a dental osteotomy in accordance with an embodiment of the present disclosure.

FIG. 15 is a drawing illustrating an example of implant placement into a dental osteotomy in a variable bone substrate in accordance with an embodiment of the present disclosure.

FIG. 16 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, an electronic device that provides information associated with a sequence of operations (such as a recommendation) is described. During operation, the electronic device may receive measurement information (such as a speed of insertion, a torque and/or a 3D position) associated with a handheld tool (such as a drill) during a dental procedure on an individual. Note that the measurements may be performed directly or may be inferred, such as based on power consumption of the drill as a function of time. Then, the electronic device may dynamically determine a sequence of operations for creating a dental osteotomy during the dental procedure based at least in part on the measurement information, such as drilling into or compressing bone. (More generally, the electronic device may determine an anatomical jaw and location of an implant or a shape of the dental osteotomy.) For example, the electronic device may dynamically determine the sequence of operations using a pretrained predictive model, such as a neural network and/or a supervised-learning model. This pretrained may account for outcomes of prior instances of the dental procedure. Thus, the dynamically determined sequence of operations may be an improved or optimal sequence of operations that results in a better or the best predicted outcome for a patient. Moreover, the electronic device may provide the information associated with the determined sequence of operations, such as: a depth, a width and/or a shape of the dental osteotomy; a sequence of tools to use during the dental procedure; a speed of insertion of the drill; an electrical draw of the drill motor; an implant design or shape to be placed; a torque of the drill; and/or a rotational energy used to insert the implant into the dental osteotomy.

By providing the information, these surgical techniques may assist a surgeon (such as an oral surgeon or a maxillofacial surgeon) by dynamically adapting a surgical plan to the specific needs or conditions associated with a patient, such as a jawbone density or quality. Moreover, the surgical techniques may allow the surgical plan to be dynamically adapted based at least in part on information that is not available a priori, such as measurements obtained by the handheld tool during the dental procedure. Consequently, the surgical techniques may help the surgeon create a hole with the correct width and/or depth, so that a dental implant can be securely attached to the patient’s jawbone. The resulting improved stability of the dental implant may improve the patient’s outcome.

In a second group of embodiments, a computer system that dynamically updates at least one predefined or predetermined sequence of operations in a set of predefined or predetermined sequences of operations is described. During operation, the computer system access at least the one predefined or predetermined sequence of operations for an instance of a type of dental procedure for an individual based at least in part on pre-operative factors, such as information associated with the individual, where the information specifies: an anatomical jaw and location of an implant and/or a shape of the dental osteotomy. For example, the information associated with the individual may include: 2D and/or 3D x-ray information associated with oral anatomy of the individual; and/or a measured current shape of a tooth and a target shape of the tooth. Moreover, the computer system may provide, addressed to the electronic device, procedure information associated with at least the one predefined or predetermined sequence of operations, and may receive feedback associated with the electronic device. The feedback may include resistance information about resistance of bone, which predicts stability of the implant after the instance of the type of dental procedure is performed. Based at least in part on the feedback, the computer system may dynamically update at least the one predefined or predetermined sequence of operations, where the updated predefined or predetermined sequence of operations is predicted to improve the stability of the implant associated with another instance of the type of dental procedure. Furthermore, the computer system may provide an intra-operative recommendation for optimal implant stability based at least in part on the updated at least one predefined or predetermined sequence of operations.

By dynamically updating at least the one predefined or predetermined sequence of operations and providing the intra-operative recommendation, these training techniques may assist a surgeon (such as an oral surgeon or a maxillofacial surgeon) by improving the quality and accuracy of surgical planning and of provided recommendations. Notably, overtime, the set of predefined or predetermined sequences of operations may be improved, so that changes or updates can be reduced or eliminated. Consequently, the training techniques may help the surgeon create a hole with the correct width and/or depth, so that a dental implant can be securely attached to a patient’s jawbone. The resulting improved stability of the dental implant may improve the patient’s outcome.

We now describe embodiments of the surgical techniques and the training techniques. In the discussion that follows, electronic devices, computers and/or servers (which may be local or remotely located from each other) may communicate packets or frames in accordance with a wired communication protocol and/or a wireless communication protocol. The wireless communication protocol may include: a wireless communication protocol that is compatible with an Institute of Electrical and Electronics Engineers (IEEE) 802.11 standard (which is sometimes referred to as ‘Wi-Fi®,’ from the Wi-Fi Alliance of Austin, Texas), Bluetooth, Bluetooth low energy, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, the wired communication protocol may include a wired communication protocol that is compatible with an IEEE 802.3 standard (which is sometimes referred to as ‘Ethernet’), e.g., an Ethernet II standard. However, a wide variety of communication protocols may be used. In the discussion that follows, Bluetooth and Ethernet are used as illustrative examples.

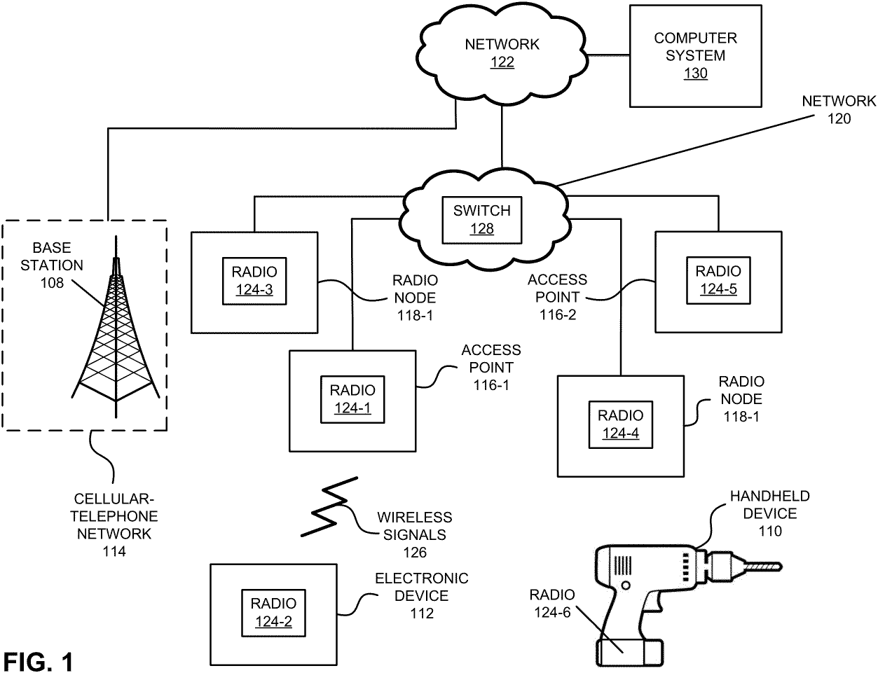

FIG. 1 presents a block diagram illustrating an example of communication between a handheld tool 110 (such as a drill) and an electronic device 112 (such as a cellular telephone, a portable electronic device, a computer or another type of electronic device, etc.). Moreover, electronic device 112 may optionally communicate via a cellular-telephone network 114 (which may include a base station 108), one or more access points 116 (which may communicate using Wi-Fi) in a wireless local area network (WLAN) and/or radio node 118 (which may communicate using LTE) in a small-scale network (such as a small cell). For example, radio node 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio node 118 may be included in one or more networks, such as: a WLAN, a small cell, a local area network (LAN) and/or a cellular-telephone network. In some embodiments, access points 116 may include a physical access point and/or a virtual access point that is implemented in software in an environment of an electronic device or a computer.

Furthermore, electronic device 112 may optionally communicate with computer system 130 (which may include one or more computers or servers, and which may be implemented locally or remotely, e.g., a cloud-based computer system, to provide storage and/or analysis services) using a wired communication protocol (such as Ethernet) via network 120 and/or 122. Note that networks 120 and 122 may be the same or different networks. For example, networks 120 and/or 122 may be a LAN, an intra-net or the Internet. In some embodiments, the wired communication protocol may include a secured connection over transmission control protocol/Internet protocol (TCP/IP) using hypertext transfer protocol secure (HTTPS) with a JavaScript object notation (JSON) Web services connection. Additionally, in some embodiments, network 120 may include one or more routers and/or switches (such as switch 128).

Handheld tool 110, electronic device 112 and/or computer system 130 may implement at least some of the operations in the surgical techniques and the training techniques. Notably, as described further below, handheld tool 110, electronic device 112 and/or computer system 130 may perform at least some of the analysis of measurement data acquired by handheld tool 110, may provide feedback to handheld tool 110 based at least in part on the measurement data, and/or may retrain a pretrained predictive model using the measurement data.

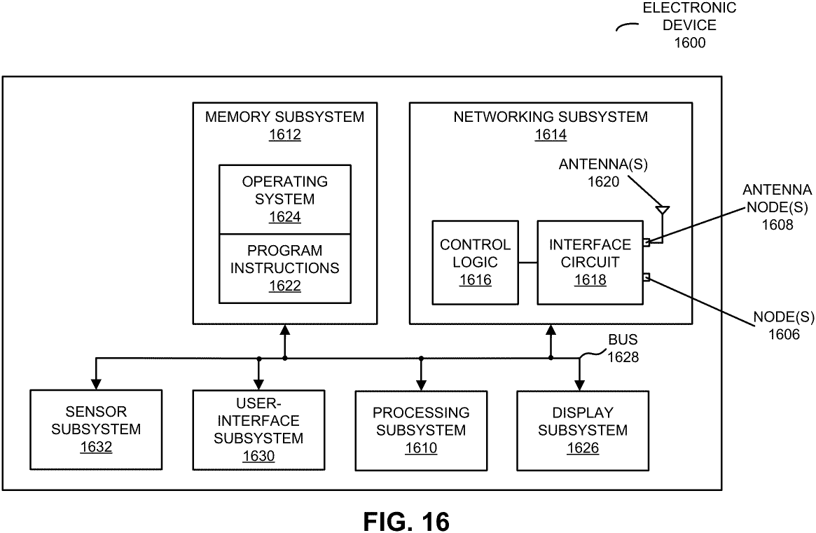

As described further below with reference to FIG. 16, base station 108, handheld tool 110, electronic device 112, access points 116, radio node 118, switch 128 and/or computer system 130 may include subsystems, such as a networking subsystem, a memory subsystem and a processing subsystem. In addition, handheld tool 110, electronic device 112, access points 116 and radio node 118 may include radios 124 in the networking subsystems. More generally, handheld tool 110, electronic device 112, access points 116 and radio node 118 can include (or can be included within) any electronic devices with the networking subsystems that enable handheld tool 110, electronic device 112, access points 116 and radio node 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, base station 108, handheld tool 110, electronic device 112, access points 116, radio node 118 and/or computer system 130 may wired or wirelessly communicate while: transmitting access requests and receiving access responses on wired or wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio node 118 and handheld tool 110 or electronic device 112. For example, radio 124-1 in access point 116-1 may transmit information (such as one or more packets or frames) using wireless signals 126. These wireless signals are received by radio 124-2 in electronic device 112. This may allow access point 116-1 to communicate information to other access points 116 and/or electronic device 112. Note that wireless signals 126 may convey one or more packets or frames.

In the described embodiments, processing a packet or a frame in one or more electronic devices in handheld tool 110, electronic device 112, access points 116, radio node 118 and/or computer system 130 may include: receiving the wireless or electrical signals with the packet or the frame; decoding/extracting the packet or the frame from the received wireless or electrical signals to acquire the packet or the frame; and processing the packet or the frame to determine information contained in the payload of the packet or the frame.

Note that the wired and/or wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

While FIG. 1 illustrates computer system 130 at a particular location, in other embodiments at least a portion of computer system 130 is implemented at more than one location. Thus, in some embodiments, computer system 130 is implemented in a centralized manner, while in other embodiments at least a portion of computer system 130 is implemented in a distributed manner.

As discussed previously, it can be difficult for an oral surgeon or a maxillofacial surgeon to create a dental osteotomy in a patient’s jaw with the correct size and depth, and/or an implant for the dental osteotomy having the correct shape. For example, it is often difficult to determine the characteristics of bone (such as density) prior to a dental procedure.

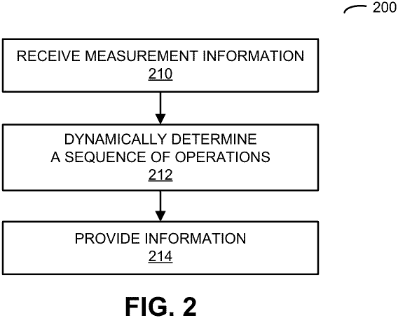

Moreover, as described further below with reference to FIGS. 2-16, in order to address these challenges, handheld tool 110 may include one or more sensors that perform measurements during a dental procedure. For example, the one or more sensors may include: a pressure sensor (which may measure the pressure between handheld tool 110 a patient’s tooth or jawbone), an acoustic sensor, an accelerometer (which may measure vibration, motion and/or orientation), a location or position sensor (such as a local positioning sensor, which may determine position relative to fiducial or reference markers, or a Global positioning sensor), a radar sensor, a LiDAR sensor, a vibration sensor, an infrared sensor (which measures electromagnetic waves in an infrared spectrum, e.g., wavelengths between 700 nm and 1 mm), an imaging sensor (which measures electromagnetic waves in a visible spectrum, e.g., wavelengths between 400 and 700 nm), a temperature sensor, an orientation sensor (which may measure an angle of handheld tool 110), a motion sensor, a pulse oximeter (such as using a photoplethysmogram), a force sensing resistor sensor (such as between handheld tool 110 and the patient’s tooth or jawbone), a torque sensor, a power sensor, a current sensor (which measures current), and/or another type of sensor.

Then, the measurements may be analyzed to determine additional information, such as such a resistance provided by the bone during the dental procedure (such as resistance of the individual’s bone to be associated with a specific depth of the dental osteotomy, which may allow a surface layer of the bone to be characterized.), and/or another metric associated with the individual and/or dental procedure This analysis may, at least in part, be performed locally (e.g., by handheld tool 110), remotely (e.g., by electronic device 112 and/or computer system 130), or jointly by handheld tool 110, electronic device 112 and/or computer system 130. For example, handheld tool 110 may provide information specifying the measurements via Bluetooth or Bluetooth low energy to electronic device 112. Then, electronic device 112 may compute the resistance and/or the other metric. Alternatively or additionally, after receiving the information specifying the measurements, electronic device 112 may provide, via networks 120 and 122, the information to computer system 130, which may compute the resistance and/or the other metric, and then may provide the analysis results to electronic device 112. As noted previously, the communication among handheld tool 110, electronic device 112 and/or computer system 130 may be secure (e.eg., encrypted and/or via a tunnel) in order to protect personal and/or medical information.

Moreover, electronic device 112 may dynamically determine a sequence of operations for creating the dental osteotomy during the dental procedure based at least in part on the measurement information and/or the analysis results. Note that dynamically determining the sequence of operations may involve updating an initial predefined or predetermined sequence of operations. More generally, electronic device 112 may determine an anatomical jaw and location of an implant and/or a shape of the dental osteotomy. For example, electronic device 112 may dynamically determine the sequence of operations using a pretrained predictive model, such as a neural network and/or a supervised-learning model. This pretrained may account for outcomes of prior instances of the dental procedure. Thus, the dynamically determined sequence of operations may be an improved or optimal sequence of operations that results in a better or the best predicted outcome for a patient.

Next, electronic device 112 may provide information associated with the determined sequence of operations, e.g., to handheld tool 110. For example, the information may include: a depth of the dental osteotomy; a width of the dental osteotomy; a shape of the dental osteotomy; a dental implant design or shape to be placed in the dental osteotomy; a sequence of tools to use during the dental procedure (such as a sequence of drills or compressive shaping tools); a speed of insertion or rotation of the drill; an electrical draw of the drill motor; a torque of the drill; and/or a rotational energy used to insert the implant into the dental osteotomy.

In some embodiments, handheld tool 110 and/or electronic device 112 may provide or present the information. Note that the information may include: the measurement results, the analysis results, and/or at least one operation in the determined sequence of operations. Notably, the information may be presented or provided to a user, such as surgeon (e.g., an oral surgeon). For example, handheld tool 110 may provide the information by selectively illuminating one or more lights (such as a green, yellow or red light emitting diode or LED), outputting sound or a tone, and/or providing instructions (e.g., verbal instructions) to guide the surgeon during the dental procedure. Alternatively or additionally, electronic device 112 may display a user interface information (such as one or more graphs) corresponding to the measurements, the analysis results, and/or the sequence of operations.

Furthermore, in some embodiments the measurements, the analysis results, the sequence of operations, and/or feedback from the surgeon may be aggregated over time, e.g., by computer system 130, into a training dataset. This aggregated information may be used to train or re-train the pretrained predictive model.

Note that the analysis of the measurements to calculate the analysis results, the determining of the sequence of operations and/or the providing of the information may be performed in a variety of ways. For example, one or more of the aforementioned operations may involve statistical calculations and/or comparisons with baseline information for one or more individuals (such as historical values stored by computer system 130).

Moreover, in some embodiments, the analysis results, the determining of the sequence of operations and/or the providing of the information may be performed using a pretrained predictive model, which was trained using a machine-learning technique (such as a supervised learning technique and/or an unsupervised learning technique) and the training dataset. For example, the pretrained predictive model may include a classifier or a regression model that was trained using: a support vector machine technique, a classification and regression tree technique, logistic regression, LASSO, linear regression, a neural network technique (such as a convolutional neural network technique, an autoencoder neural network or another type of neural network technique) and/or another linear or nonlinear supervised-learning technique. The pretrained predictive model may use measurements and/or analysis results as inputs and may output: the analysis results, the sequence of operations, and/or the information.

As noted previously, computer system 130 may dynamically retrain the pretrained predictive model based at least in part on updates to the training dataset (such as recent measurements, analysis results, the sequence of operations and/or feedback from the surgeon), and then may provide an updated pretrained predictive model to: handheld tool 110 and/or electronic device 112. The updated predictive model may be used for more accurate planning of a future type of dental procedure.

For example, during surgical planning, computer system 130 may determine, using a pretrained predictive model, information for a planned or future instance of a type of dental procedure for an individual based at least in part on information associated with the individual. In some embodiments, the information associated with the individual that is used to determine the provided information may include: 2D and/or 3D x-ray information associated with oral anatomy of the individual; and/or a measured current shape of a tooth and a target shape of the tooth. Moreover, the provided information may specify: an anatomical jaw and location of an implant, a shape of the implant, a shape of the dental osteotomy and/or a sequence of operations during the dental procedure.

Then, computer system 130 may provide the determined information addressed to electronic device 112. This provided information may be used during the instance of the type of dental procedure. Handheld device 110 may perform measurements during the instance of the type of dental procedure, which are provided to electronic device 112. Next, electronic device 112 may provide feedback to computer system 130, where the feedback includes the measurements and/or analysis results corresponding to the measurements. Note that the feedback may include resistance information about resistance of bone, which predicts stability of an implant for the instance of the type of dental procedure.

Based at least in part on the feedback, computer system 130 may dynamically update the pretrained predictive model, where the updated pretrained predictive model is predicted to improve the stability of the implant associated with another instance of the type of dental procedure. Then, computer system 130 may provide the updated pretrained predictive model to: handheld tool 110 and/or electronic device 112.

While the preceding discussion illustrated the use of computer system 130 to perform the surgical planning and to update the pretrained predictive model, in other embodiments at least some of these operations performed by computer system 130 are performed by handheld tool 110 and/or electronic device 112.

Moreover, while the preceding discussion illustrated updating of the pretrained predictive model, in other embodiments the provided information may be associated with a predefined or predetermined sequence of operations, and computer system 130, handheld tool 110 and/or electronic device 112 may access the predefined or predetermined sequence of operations based at least in part on information associated with the patient and may update at least the predefined or predetermined sequence of operations based at least in part on the feedback.

In these ways, the surgical techniques and/or the training techniques may facilitate improved patient outcomes. Notably, the surgical techniques may assist a surgeon by dynamically adapting a surgical plan to the specific needs or conditions associated with a patient, such as a jawbone density or quality. Consequently, the surgical techniques may help the surgeon create a dental osteotomy with the correct width and/or depth, and/or an implant with the correct shape, so that a dental implant can be securely attached to the patient’s jawbone. The resulting improved stability of the dental implant may improve the patient’s outcome.

Moreover, the training techniques may allow a pretrained predictive model and/or at least the predefined or predetermined sequence of operations to be updated (e.g., continuously, periodically or as needed) based at least in part on feedback received from the surgeon and/or measurements performed during an instance of a type of dental procedure. These updates may improve the accuracy of the pretrained predictive model and/or the predefined or predetermined sequence of operations, so that changes made by the surgeon relative to information or recommendation(s) provided by the pretrained predictive model are reduced or eliminate over time. Consequently, the training techniques may help the surgeon create a dental osteotomy with the correct width and/or depth, and/or an implant with the correct shape, so that a dental implant can be securely attached to a patient’s jawbone. Once again, the resulting improved stability of the dental implant may improve the patient’s outcome.

While the preceding embodiments illustrated the use of the surgical techniques and the training techniques in conjunction with a dental procedure, in other embodiments the surgical techniques and/or the training techniques may be used with a wide variety of types of surgeries, such as orthopedic surgery. Notably, during a type of surgical procedure, measurements may be performed (e.g., using a handheld surgical tool and, more generally, a measurement sensor), and the measurements may be used to dynamically determine a sequence of operations and/or information that is provided to a surgeon. Thus, during, e.g., a hip replacement surgery, measurements may be performed using a drill, and the measurements may be used to dynamically determine the sequence of operations and/or the information that is provided to a surgeon.

We now describe embodiments of the method. FIG. 2 presents a flow diagram illustrating an example of a method 200 for providing information associated with a sequence of operations, which may be performed by an electronic device, such as electronic device 112 in FIG. 1). During operation, the electronic device may receive measurement information (operation 210) associated with the handheld tool during a dental procedure on an individual.

Note that the handheld tool may include a type of drill. Furthermore, the measurement information may correspond to resistance of the individual’s bone to cutting or compressing operations during the dental procedure (such as resistance at the crest or the bottom). Additionally, the measurement information comprises a 3D position of the handheld tool (which may be determined using a local positioning system and/or a Global positioning system). For example, the 3D position may be relative to oral anatomy of the individual, such as a jawbone of the individual. In some embodiments, the measurement information may correspond to power consumption as a function of time of the handheld tool during the dental procedure. For example, the measurement information may include: a torque of the handheld tool as a function of time; a rotational energy of the handheld tool; and/or an electrical current associated with the handheld tool as a function of time.

Then, the electronic device may dynamically determine a sequence of operations (operation 212) for creating a dental osteotomy during the dental procedure based at least in part on the measurement information. For example, the sequence of operations may include: a speed of rotation or insertion of a drill; a torque of the drill; and/or rotation energy used to insert an implant into the dental osteotomy. More generally, the sequence of operations may include or may correspond to a sequence of drills or compressive tools. Moreover, the dental osteotomy may include: drilling into bone; and/or compressing the bone. Furthermore, the dental osteotomy may be associated with the implant. Note that the determined sequence of operations may include an output of a pretrained predictive model. For example, the pretrained predictive model may include: a neural network; and/or a supervised-learning model.

Next, the electronic device may provide the information (operation 214) based at least in part on the determined sequence of operations. For example, the information may include: a depth of the dental osteotomy, a width of the dental osteotomy and/or a shape of the dental osteotomy. Moreover, the information may include a sequence of tools to use during the dental procedure. In some embodiments, the information may include: a speed of insertion or rotation of the drill; a torque of the drill; an electrical draw of the drill motor; and/or a rotation energy used to insert the implant into the dental osteotomy.

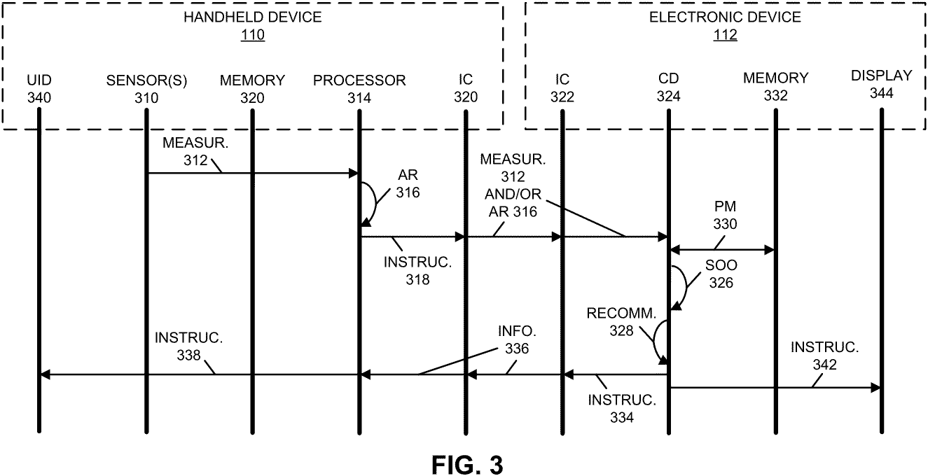

Embodiments of the surgical techniques are further illustrated in FIG. 3, which presents a drawing illustrating an example of communication among components in handheld tool 110 and electronic device 112. In FIG. 3, one or more sensors 310 in handheld 110 may perform measurements 312 during a dental procedure. These measurements may be provided to a processor 314 in handheld tool 110.

Then, processor 314 may optionally analyze measurements 312 to calculate one or more analysis results (AR) 316. Moreover, processor 314 may instruct 318 an interface circuit (IC) 320 in handheld tool 110 to provide measurements 312 and/or analysis results 316 to electronic device 112.

After receiving measurements 312 and/or analysis results 316, an interface circuit 322 in electronic device 112 may provide measurements 312 and/or analysis results 316 to computation device (CD) 324 in electronic device 112, such as a processor or a graphics processing unit (GPU). Next, computation device 324 may determine a sequence of operations (SOO) 326 based at least in part on measurements 312 and/or analysis results 316. Furthermore, computation device 324 may compute a recommendation 328 based at least in part on the determined sequence of operations 328.

For example, sequence of operations 326 and/or recommendation 328 may be dynamically determined by computation device 324 using a pretrained predictive model (PM) 330, which computation device 324 accesses in memory 332 in electronic device 112. This pretrained predictive model may use measurements 312 and/or analysis results 316 as inputs, and may output sequence of operations 326. Alternatively or additionally, pretrained predictive model 330 may use sequence of operations 326 as inputs, and may output recommendation 328.

Next, computation device 324 may provide an instruction 334 to interface circuit 322. In response, interface circuit 322 may provide one or more packets or frames to handheld tool 110 with information 336 specifying or corresponding to sequence of operations 326 and/or recommendation 328.

After receiving the one or more packets or frames, interface circuit 320 may provide information 336 to processor 314. Processor 314 may instruct 338 or may provide signals to a user-interface device (UID) 340 in handheld tool 110 to present or provide information corresponding to or that specifies sequence of operations 326 and/or recommendation 328. For example, user-interface device 340 may include LEDs that are selectively illuminated to provide feedback about a drill speed and/or torque.

Alternatively or additionally, computation device 324 may provide an instruction 342 to display 344 in electronic device 112 to display sequence of operations 326 and/or recommendation 328. In some embodiments, electronic device 112 may output sound (such as verbal instructions using a voice generation technique) based at least in part on sequence of operations 326 and/or recommendation 328.

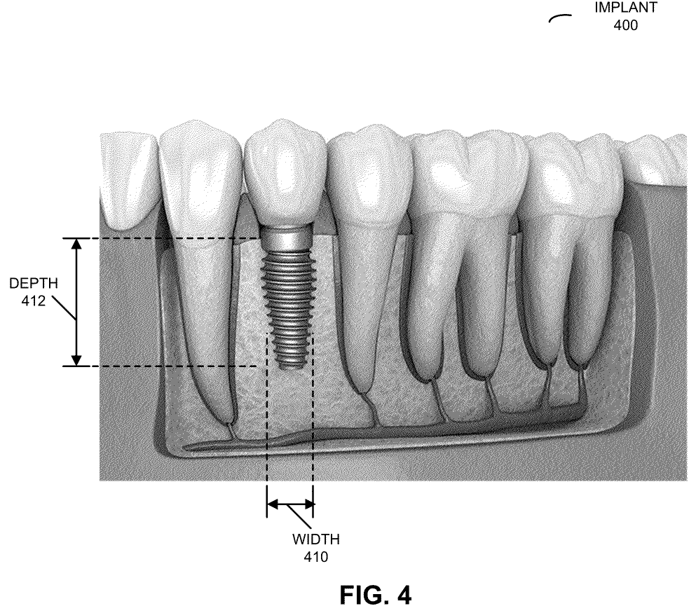

FIG. 4 presents a drawing illustrating an example of an implant 400 in a dental osteotomy. This dental osteotomy may have a width 410 and a depth 412. Depending on characteristics of the surrounding bone (such as the bone density and/or stiffness), a different sequence of operations (such as different handheld or dental tools, e.g., different drill types or sizes) may be used in a dental procedure while creating the dental osteotomy. Alternatively or additionally, different insertion speeds, rotation speeds and/or torques of a drill or a compressive shaping tool (and, more generally, tool operating parameters) may be used. Using the surgical techniques, the sequence of operations and/or tool operating parameters may be dynamically determined or adapted based at least in part on measurements associated with operation of the handheld tool (such as a drill and, more generally, a surgical tool or instrument). For example, the sequence of operations and/or tool operating parameters may be dynamically determined or adapted based at least in part on: resistance provide by bone of the individual during the dental procedure; a 3D position of the handheld tool (such as a location and/or an orientation); power consumption as a function of time of the handheld tool during the dental procedure (such as a torque of the handheld tool as a function of time, rotational energy of the handheld tool as a function of time, and/or an electrical current associated with the handheld tool as a function of time). Notably, a ¾″ or a ⅞″ drill may be used, and a customized sequence of operations may include: run a given drill at a particular speed, twist, run the given drill in reverse, insert implant with threads using a particular toque, etc.

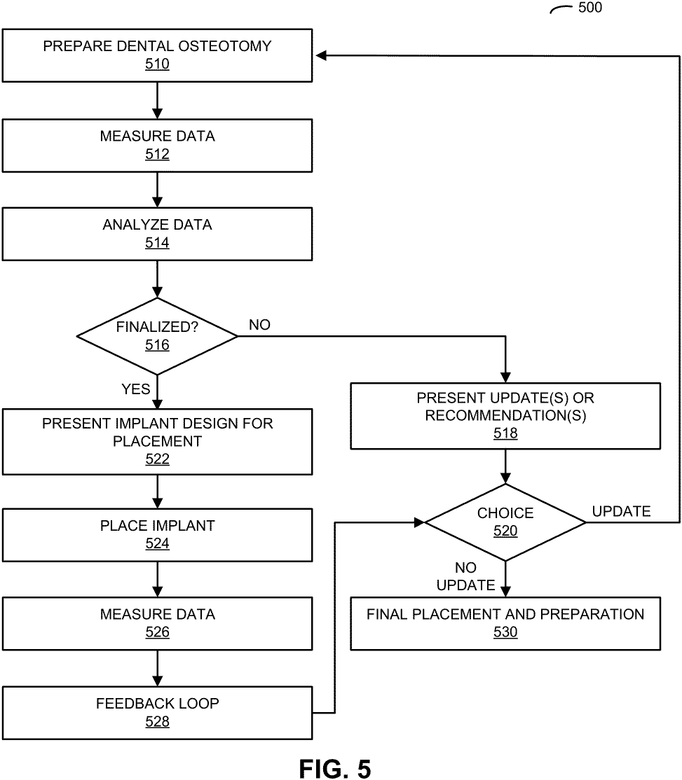

FIG. 5 presents a drawing illustrating an example of a method 500 for providing information (such as a recommendation) using electronic device 112 (FIG. 1). Note that the surgical techniques may be specific to a particular implant design and preparation protocol (such as one of 10 sequences). Moreover, the surgical techniques may be tailored to follow user-implant placement outcomes (such as always loose, always tight, etc.). Furthermore, the preparation protocol could involve a subtractive and/or an expansive approach for a dental osteotomy.

Notably, during digital planning of implant position/dimensions, a user (such as a surgeon) may select an initial protocol (such as an initial predefined or predetermined sequence of operations to perform during the dental osteotomy) and implant based at least in part on clinical conditions, such as: dense versus soft bone, jaw, position, healed site, etc.).

Then, during the surgical techniques: a dental osteotomy may be prepared (operation 510); data may be measured or acquired (operation 512); the data may be analyzed (operation 514); a determination is made as to whether the dental osteotomy is finalized (operation 516) or whether additional preparation is needed (operation 516), in which case a preparation sequence is recalculated).

When additional preparation is needed (operation 516), a user may be presented with updates or a recommendation (operation 518), such as: a preparation protocol; and/or an implant design. The user may choose (operation 520) to keep the original preparation plan or to follow the updated preparation plan (such as a determined sequence of operations).

Alternatively, when the dental osteotomy is finalized (operation 516), the user may be presented with an implant design for placement (operation 522). Then, the implant may be placed into the final dental osteotomy (operation 524); data may be acquired at placement (operation 526); and a feedback loop may be used (operation 528) to customize the surgical techniques to user tendencies.

Once the implant placement is finalized (operation 520), final placement data and a selected preparation sequence (or sequence of operations) may be provided (operation 530) to computer system 130 (FIG. 1) to assist in developing the surgical techniques, such as updating a pretrained predictive model that determines the recommendation.

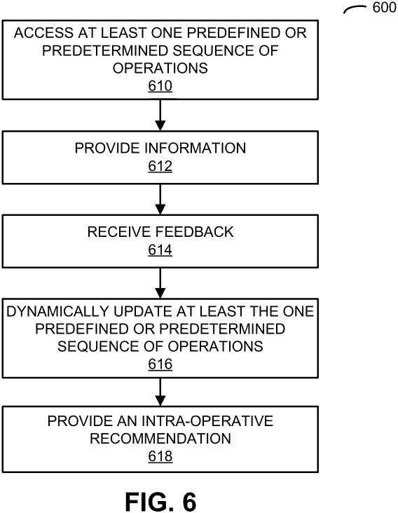

FIG. 6 presents a flow diagram illustrating an example of a method 600 for dynamically updating at least one predefined or predetermined sequence of operations in a set of predefined or predetermined sequences of operations, which may be performed by a computer system, such as computer system 130 in FIG. 1). During operation, the computer system may access the at least one predefined or predetermined sequence of operations (operation 610) associated with a type of dental procedure, such as a dental osteotomy. For example, at least the one predefined or predetermined sequence of operations may be accessed based at least in part on pre-operative factors, such as: an anatomical location of an instance of the type of dental procedure (and, more generally, information associated with an individual), predictions from 3D imaging and/or a preference of a surgeon. Note that the set of predefined or predetermined sequences of operations (such as different possible sequences of surgical tools and/or surgical operations that can be used in a given instance of the type of dental procedure) may be initial sequences of operations that can be used for different patients and that may be based at least in part on prior measurement results collected during historical instances of the type of dental procedure performed on multiple individuals and prior outcome metrics of the historical instances of the type of dental procedure. Moreover, a given outcome metric may have been determined within 1 hr. of completion of a given historical instance of the type of surgical procedure. Furthermore, a given outcome metric may have been determined more than six months after completion of a given historical instance of the type of surgical procedure. In some embodiments, the type of dental procedure may include creating a dental osteotomy.

Then, the computer system may provide, addressed to the electronic device information (operation 612) associated with at least the one predefined or predetermined sequence of operations.

Note that the information associated with the individual may include: 2D and/or 3D x-ray information associated with oral anatomy of the individual; and/or a measured current shape of a tooth and a target shape of the tooth.

Moreover, the computer system may receive feedback (operation 614) associated with the electronic device. The feedback may include resistance information about resistance of bone during the instance of the dental procedure, which predicts stability of an implant after the instance of the type of dental procedure.

Based at least in part on the feedback, the computer system may dynamically update (operation 616) at least the one of the predefined or predetermined sequence of operations, and may provide an intra-operative recommendation (operation 618) based at least in part on at least the one predefined or predetermined sequence of operations to the surgeon for optimal implant primary stability.

Note that the recommendation may include: a depth of the dental osteotomy and/or a width of the dental osteotomy. Furthermore, the recommendation may include a sequence of tools to use during the instance of the type of dental procedure. Additionally, the recommendation may include: a speed of insertion of a drill; a torque of the drill; and/or a torque or rotational energy (corresponding to a product of the torque and rotation) used to insert the implant into the dental osteotomy.

In some embodiments, the feedback may include: a first change to the shape of the implant when the instance of the type of dental procedure was performed; and/or a second change to the sequence of operations when the instance of the type of dental procedure was performed. Moreover, the update to at least the one of the predefined or predetermined sequences of operation may be predicted to reduce a size of the first change, and/or a size of the second change associated with another instance of the type of dental procedure. Thus, the recommendations from the updated pretrained predictive model may be more accurate, so that any revisions are reduced or eliminated.

Note that the stability may correspond to: a peak torque of a handheld tool that was used when the instance of the type of dental procedure was performed; rotational energy used to deliver the implant to a planned position; and/or stability information associated with vibration of the implant after the instance of the type of dental procedure was performed (e.g., resonant frequency analysis may be used to determine a stability quotient or a stiffness of substrate). In some embodiments, the stability information is associated with a response to an impact or a bump applied to the implant.

In some embodiments of method 200 (FIG. 2), 500 (FIG. 5) and/or 600, there may be additional or fewer operations. Furthermore, the order of the operations may be changed, and/or two or more operations may be combined into a single operation.

Moreover, in some embodiments, instead of or in addition to updating at least the one predefined or predetermined sequence of operations, the computer system may update a pretrained predictive model (which may provide the recommendation), such as: a neural network; and/or a supervised-learning model.

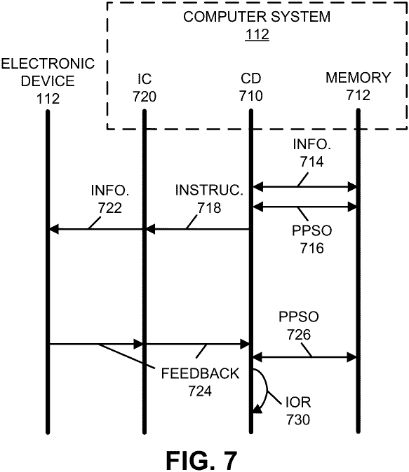

Embodiments of the training techniques are further illustrated in FIG. 7, which presents a drawing illustrating an example of communication among components in electronic device 112 and computer system 130. Notably, computation device 710 in computer system 130 (such as a processor or a GPU) may access at least a predefined or predetermined sequence of operations (PPSO) 716 associated with a type of dental procedure (such as a dental osteotomy) in a set of predefined or predetermined sequences of operations in memory 712 in computer system 130. For example, computation device 710 may access at least the predefined or predetermined sequence of operations 716 based at least in part on information 714, such as pre-operative information and/or information associated with an individual in memory 712. Note that information 714 may include: an anatomical location of an instance of the type of dental procedure (and, more generally, information associated with an individual); 2D and/or 3D x-ray information associated with oral anatomy of the individual; a measured current shape of a tooth and a target shape of the tooth; and/or a preference of a surgeon.

Note that the set of predefined or predetermined sequences of operations may be associated with prior measurement results (such as drilling or cutting resistance of bone) collected during historical instances of the type of dental procedure performed on multiple individuals and/or prior outcome metrics of the historical instances of the type of dental procedure (such as implant stability 1 hr., 1 week, 1 months, six months or a year after the historical instances of the type of dental procedure).

Then, computation device 710 may instruct 718 interface circuit 720 in computer system 130 to provide, to electronic device 112, information 722 associated with at least the predefined or predetermined sequence of operations 716 for an instance of the type of dental procedure for an individual, where information 722 may include or specify: an anatomical jaw and location of an implant, a shape of the implant, a depth of the dental osteotomy, a width of the dental osteotomy, a shape of the dental osteotomy a sequence of operations during the planned dental procedure (such as a sequence of tools to use), a speed of insertion of a drill, a torque of the drill, and/or a rotational energy used to insert the implant into the dental osteotomy.

After receiving information 722, electronic device 112 may present information 722 to a user (such as a surgeon). For example, electronic device 112 may display information 722 in a user interface on a display and/or may output sound (such as verbal instructions corresponding to information 722 using a voice generation technique).

Subsequently, electronic device 112 may provide feedback 724 to computer system 130. For example, the user may review information 722 and then may provide feedback 724. Alternatively or additionally, feedback 724 may be determined during or after the instance of the type of dental procedure. Notably, feedback 724 may include or may correspond to measurements performed by a handheld tool during the instance of the type of dental procedure. As discussed previously, these measurements may include: a peak torque of the handheld tool, power consumption of the handheld tool, current of the handheld tool, etc. Moreover, feedback 724 may include or may correspond to stability of the implant after the instance of the type of dental procedure (such as vibration of the implant in the dental osteotomy after 1 hr., 1 day, 1 week, 1 month, six months or a year).

After receiving feedback 724, interface circuit 720 may provide feedback 724 to computation device 710. Then, computation device 710 may revise 726 at least the predefined or predetermined sequence of operations 728 stored in memory 712. Note that the revised predefined or predetermined sequence of operations 728 may be predicted to improve the stability of the implant associated with another instance of the type of dental procedure.

Next, computation device 710 may determine an inter-operative recommendation (IOR) 730 based at least in part on at least the updated predefined or predetermined sequence of operations 728 to the surgeon for optimal implant primary stability. Furthermore, computation device 710 may provide the intra-operative recommendation 730 to the user for optimal implant primary stability. For example, computation device 710 may instruct interface circuit 718 to provide the intra-operative recommendation 730 to electronic device 112. After receiving the intra-operative recommendation 730, electronic device 112 may present the intra-operative recommendation 730 to the user. Notably, electronic device 112 may display the intra-operative recommendation 730 in a user interface on a display and/or may output sound (such as verbal instructions corresponding to the intra-operative recommendation 730 using a voice generation technique).

While FIGS. 3 and 7 illustrates communication between components using unidirectional or bidirectional communication with lines having single arrows or double arrows, in general the communication in a given operation in this figure may involve unidirectional or bidirectional communication.

We now further describe embodiments of the surgical techniques and the training techniques. In some embodiments, the surgical techniques may include or provide a surgical guide that delivers an implant with a predefined rotation, timing and/or position. For example, the surgical guide may include a mouthguard with a physical or a mechanical stop at a precise individual-specific location and depth in order to provide a reference point to stop insertion of the implant. Alternatively or additionally, the surgical techniques may include or provide a wrench or tool that works with the implant and that provides a predefined torque in conjunction with the mouthguard so that the implant can be inserted in a reproducible manner for a given jaw geometry.

For example, instead of or in addition to a visual notch or grove in a cylinder that an oral surgeon attempts to align with, the physical stop may be separated from the notch, thereby providing more angular precision in delivering the implant at the correct location, orientation and insertion torque. Notably, if the torque used to insert the implant is too large, bone may facture or threads on the implant may strip. More generally, if the torque is too large or too small, implant stability may be adversely affected.

Moreover, in some embodiments of the surgical techniques, a tooth shape may be changed to make a crown or sleeve. Notably, a digital surgical plan may be provided with planned material thickness to drive robustness. Typically, the surgical plan works from the outside of the tooth inward over the course of the dental procedure. However, because the density and/or strength of the tooth may vary with position, a surgical plan based on tooth shape may not properly account for the variations in material properties, such as density. Consequently, 3D analysis of a patient’s mouth before a dental procedure may not be sufficient. In order to address these challenges, in the surgical techniques a physical scan of a tooth may be captured and information corresponding to a planned shape in the surgical plan may be overlaid in a user interface (such as augmented or virtual reality) to compare the shape that has been generated with the planned shape in the surgical plan. In some embodiments, differences between the planned shape and the actual shape may be color coded to reflect, e.g., different depth deviations.

Furthermore, in some embodiments of the surgical techniques, dynamical recommendations may be provided during a surgical procedure in order to assess and improve stability of a prefabricated implant. Notably, a recommendation may be based at least in part on dynamic feedback provided by a drill, such as measurements that characterize a density of bone and/or a resistance to cutting. For example, different drills may measure a speed of insertion when they are used. This measurement information may be used to determine and provide a recommendation during a current dental procedure and/or to assist in developing a surgical plan for another planned or future instance of the dental procedure.

In some embodiments, the measured information may be aggregated over time from one or more drills. In addition, the corresponding outcomes (such as implant stability) may be collected. This dataset may be used to train one or more pretrained predictive models, which may provide the recommendation for a given dental procedure. For example, the recommendation may include: a sequence of drills to use, a torque to use during drilling or insertion of an implant (such as a maximum torque), and/or a specific screw design for a particular patient or individual (which may be selected from a set of predefined screw designs). Additionally, in some embodiments, the pretrained predictive model may be customized to an individual surgeon or to a group of two or more surgeons. Thus, there may be different pretrained predictive model for different handheld tools, different types of dental procedures and/or for different surgeons (such as different oral surgeons).

Note that the surgical techniques may be generalized to other dental procedures and, more generally, to a wide variety of surgical procedures (such as orthopedic surgery and/or general surgery). For example, a handheld tool that inserts an implant may track rotation and/or torque. These measurements may be used to provide feedback in the current dental procedure and/or to assist in developing a surgical plan for another planned or future instance of the dental procedure.

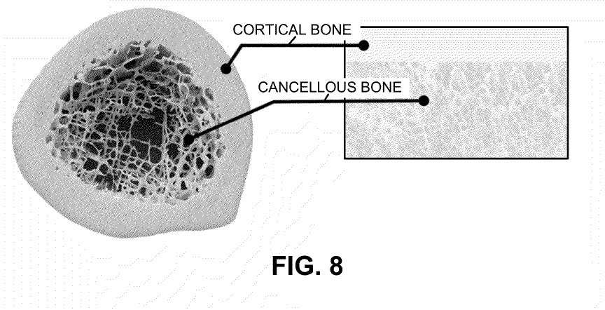

FIG. 8 presents a drawing illustrating an example of a cross-section of human bone, which shows the mechanical structure of the bone. Note that cortical bone is a dense outer layer with better mechanical properties (such as a larger Young’s modulus), and cancellous bone is a spongy inner layer with space for tissue, but which has less favorable mechanical properties.

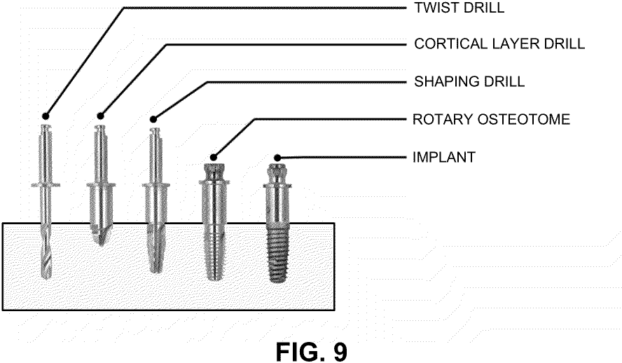

FIG. 9 presents a drawing illustrating an example of a sequence of operations using different instruments in a dental osteotomy, including: using a twist drill to provide an initial assessment of bone via cutting resistance; using a cortical layer drill that enlarges the dental osteotomy in a dense surface later of bone; using a shaping drill to cut (remove) bone to create the dental osteotomy shape; and using a rotary osteotome to compress bone into a final dental osteotomy shape. As shown in FIG. 9, the final implant is inserted into the dental osteotomy with interface fit for stability.

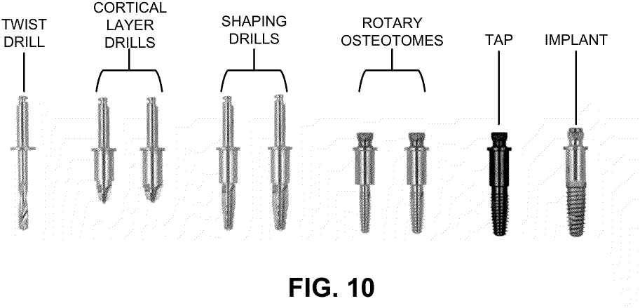

FIG. 10 presents a drawing illustrating examples of different types of drills and an implant. Notably, FIG. 10 illustrates: a twist drill; small and regular cortical layer drills; small and regular shaping drills; small and regular osteotomes; a tap; and an implant on a mount.

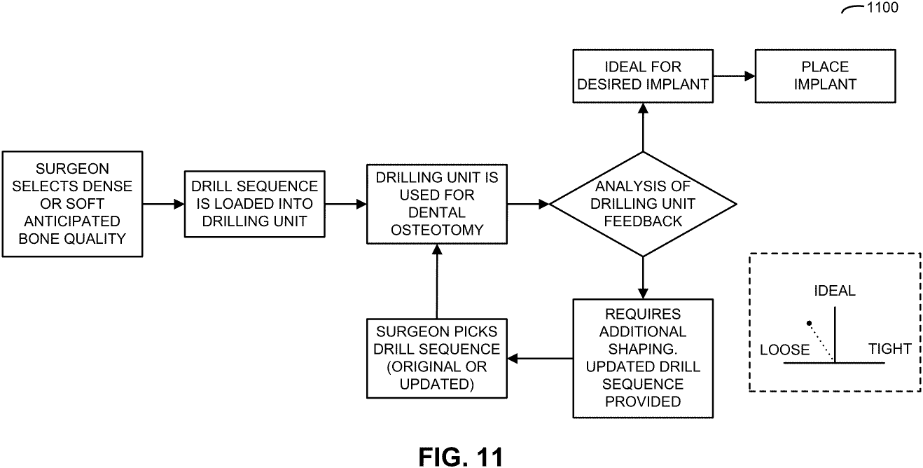

FIG. 11 presents a drawing illustrating an example of a method 1100 for providing information using an electronic device in FIG. 1. Notably, a surgeon may select or specify dense or soft anticipated bone quality, which is then loaded into a drilling unit (such as handheld device 110). Then, the surgeon may use handheld device 110 to create the dental osteotomy. Moreover, feedback from the handheld device 110 may be analyzed by computer system 130. For example, the feedback may include: a current, a torque, a rotational energy, and/or a rotational speed. Furthermore, as shown in the inset, a graphical representation may be presented (e.g., by electronic device 112) indicating to the surgeon how the dental osteotomy is progressing.

When the dental osteotomy is ideal for a desired implant, the surgeon may place the implant. Alternatively, when computer system 130 determines that the dental osteotomy needs additional shaping, a drill sequence may be updated in handheld device 110 and/or a recommendation may be provided. In some embodiments, the surgeon may select the sequence of operation (such as the initial or the updated sequence of operations). Next, the surgeon may use handheld device 110 to create the dental osteotomy.

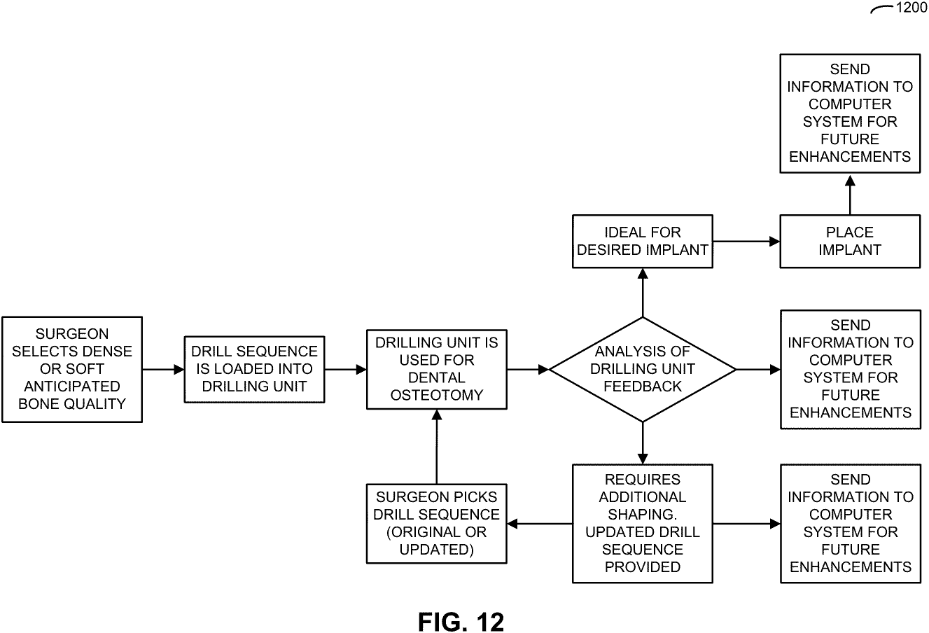

FIG. 12 presents a drawing illustrating an example of a method 1200 for providing information using an electronic device in FIG. 1. In this method, the drill system (such as handheld device 110 and/or electronic device 112) may track: a sequence of operations selected by the surgeon; an energy used by each shaping operation (which may be correlated or statistically associated with position); a final implant torque; an energy used to place the implant; and/or a vertical position of the implant at the end of placement operation. This tracked information may be provided to a computer system (such as computer system 130) for future enhancements, e.g., of a set of predefined or predetermined sequences of operations and/or of a pretrained predictive model.

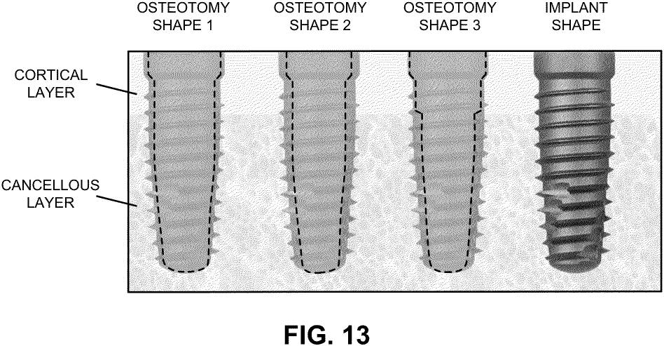

FIG. 13 presents a drawing illustrating an example of a sequence of operations in a dental osteotomy. In FIG. 13, the shaded region represents a dental osteotomy or hole created in bone to receive an implant. Note that the sequence of operations may include a dental osteotomy shape 1 with a uniform interference fit. Alternatively, the sequence of operations may include a dental osteotomy shape 2 with a greater uniform interference fit (which is not customized to bone quality). In some embodiments, the sequence of operations may include a dental osteotomy shape 3 with a customized interference fit (with greater interference for poor quality none). In addition, FIG. 13 illustrates the implant shape advanced into the dental osteotomy.

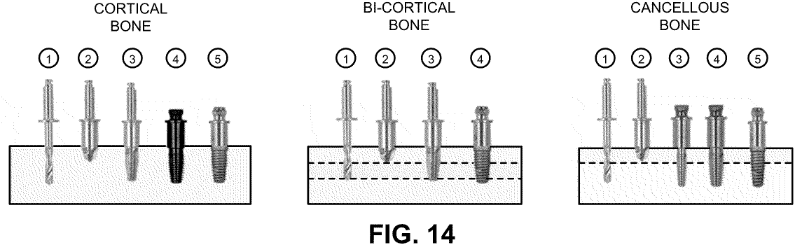

FIG. 14 presents a drawing illustrating examples of sequences of operations in a dental osteotomy. In general, the sequence of operations in dental osteotomy preparation may include or may use: a twist drill, a small cortical layer drill, a regular cortical layer drill, a small shaping drill, a regular shaping drill, a small rotary osteotome, a regular rotary osteotome, a tap, and/or an implant (on a mount). However, the instrument sequence (and, thus, the operations) may be customized. For example, for dense supportive bone quality in cortical bone, a sequence of operations may include: use of a twist drill to provide an initial assessment (which may indicate that the bone is completely dense), use of a sequence of larger drills to remove bone (such as use of a regular cortical layer drill and then a regular shaping drill), use of a tap for final enlargement, and insertion of an implant on a mount. Moreover, for dense bone at the top and bottom of a dental osteotomy with soft spongy bone in between, a sequence of operations may include: use of a twist drill to provide an initial assessment (which may indicate that the bone is dense at the top and the bottom), use of a sequence of larger drills to remove bone (such as use of a regular cortical layer drill and then a regular shaping drill), and insertion of an implant on a mount. Furthermore, for dense bone at the top and bottom of a dental osteotomy with soft spongy bone in between, a sequence of operations may include: use of a twist drill to provide an initial assessment (which may indicate that the bone is only dense at the outer layer), use of a small cortical layer drill, use of a small rotary osteotome to expand the bone, use of a regular osteotome to further expand the bone, and insertion of an implant on a mount.

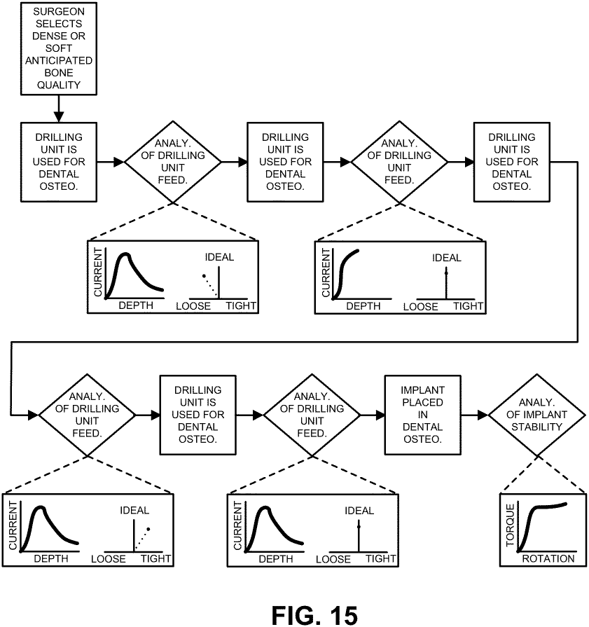

FIG. 15 presents a drawing illustrating an example of implant placement into a dental osteotomy in a variable bone substrate. Notably, the bone may be dense at the beginning of the dental osteotomy, with soft, spongy bone internally. Selecting from the instruments illustrated in FIG. 10, a surgeon may select a twist drill based on an initial anticipated dense bone quality. The initial feedback based on the drill measurements (such as DC current draw versus drill depth) may predict a dense surface layer and soft inner bone. Consequently, the proposed sequence may indicate cutting/expansion, and a graphical representation or indication of how the dental osteotomy is progressing (such as loose) may be displayed for the surgeon.

Moreover, a small cortical layer drill may be proposed to continue the dental osteotomy. The feedback based on the drill measurements may confirm a dense cortical layer and may recommend that the sequence be continued using a small rotary osteotome for expansion of the dental osteotomy. In addition, and a graphical representation or indication of how the dental osteotomy is progressing (such as ideal) may be displayed for the surgeon.

Furthermore, after the small rotary osteotome has been used, the feedback based on the drill measurements may predict a dense cortical layer and soft inner bone. Consequently, a regular osteotome may be recommended for continued expansion of the dental osteotomy, and a graphical representation or indication of how the dental osteotomy is progressing (such as tight) may be displayed to the surgeon.

Additionally, after the regular rotary osteotome has been used, the feedback based on the drill measurements may continue to predict a dense cortical layer and soft inner bone. Consequently, a tap and then implant placement in the dental osteotomy may be recommended, and a graphical representation or indication of how the dental osteotomy is progressing (such as ideal) may be displayed for the surgeon.

After implant placement, the implant stability may be analyzed or assessed. For example, the measured insertion torque as a function of rotation angle (or the area under the curve) may be measured and displayed to the surgeon and/or may be provided to a cloud-based computer system to assess the outcome of the sequence used to create the dental osteotomy.

We now describe embodiments of an electronic device, which may perform at least some of the operations in the surgical techniques and/or the training techniques. FIG. 16 presents a block diagram illustrating an example of an electronic device 1600, e.g., handheld tool 110, electronic device 112, access points 116, radio node 118, switch 128 and/or a computer or server in computer system 130, in accordance with some embodiments. For example, electronic device 1600 may include: processing subsystem 1610, memory subsystem 1612, and networking subsystem 1614. Processing subsystem 1610 includes one or more devices configured to perform computational operations. For example, processing subsystem 1610 can include one or more microprocessors, ASICs, microcontrollers, programmable-logic devices, GPUs and/or one or more DSPs. Note that a given component in processing subsystem 1610 are sometimes referred to as a ‘computation device’.

Memory subsystem 1612 includes one or more devices for storing data and/or instructions for processing subsystem 1610 and networking subsystem 1614. For example, memory subsystem 1612 can include dynamic random access memory (DRAM), static random access memory (SRAM), and/or other types of memory. In some embodiments, instructions for processing subsystem 1610 in memory subsystem 1612 include: program instructions or sets of instructions (such as program instructions 1622 or operating system 1624), which may be executed by processing subsystem 1610. Note that the one or more computer programs or program instructions may constitute a computer-program mechanism. Moreover, instructions in the various program instructions in memory subsystem 1612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1610.

In addition, memory subsystem 1612 can include mechanisms for controlling access to the memory. In some embodiments, memory subsystem 1612 includes a memory hierarchy that comprises one or more caches coupled to a memory in electronic device 1600. In some of these embodiments, one or more of the caches is located in processing subsystem 1610.

In some embodiments, memory subsystem 1612 is coupled to one or more high-capacity mass-storage devices (not shown). For example, memory subsystem 1612 can be coupled to a magnetic or optical drive, a solid-state drive, or another type of mass-storage device. In these embodiments, memory subsystem 1612 can be used by electronic device 1600 as fast-access storage for often-used data, while the mass-storage device is used to store less frequently used data.

Networking subsystem 1614 includes one or more devices configured to couple to and communicate on a wired and/or wireless network (i.e., to perform network operations), including: control logic 1616, an interface circuit 1618 and one or more antennas 1620 (or antenna elements). (While FIG. 16 includes one or more antennas 1620, in some embodiments electronic device 1600 includes one or more nodes, such as antenna nodes 1608, e.g., a metal pad or a connector, which can be coupled to the one or more antennas 1620, or nodes 1606, which can be coupled to a wired or optical connection or link. Thus, electronic device 1600 may or may not include the one or more antennas 1620. Note that the one or more nodes 1606 and/or antenna nodes 1608 may constitute input(s) to and/or output(s) from electronic device 1600.) For example, networking subsystem 1614 can include a Bluetooth™ networking system, a cellular networking system (e.g., a 3G/4G/5G network such as UMTS, LTE, etc.), a USB networking system, a networking system based on the standards described in IEEE 802.11 (e.g., a Wi-Fi® networking system), an Ethernet networking system, and/or another networking system.

Networking subsystem 1614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between electronic devices does not yet exist. Therefore, electronic device 1600 may use the mechanisms in networking subsystem 1614 for performing simple wireless communication between electronic devices, e.g., transmitting advertising or beacon frames and/or scanning for advertising frames transmitted by other electronic devices.

Within electronic device 1600, processing subsystem 1610, memory subsystem 1612, and networking subsystem 1614 are coupled together using bus 1628. Bus 1628 may include an electrical, optical, and/or electro-optical connection that the subsystems can use to communicate commands and data among one another. Although only one bus 1628 is shown for clarity, different embodiments can include a different number or configuration of electrical, optical, and/or electro-optical connections among the subsystems.

In some embodiments, electronic device 1600 includes a display subsystem 1626 for displaying information on a display, which may include a display driver and the display, such as a liquid-crystal display, a multi-touch touchscreen, etc. Moreover, electronic device 1600 may include a user-interface subsystem 1630, such as: a mouse, a keyboard, a trackpad, a stylus, a voice-recognition interface, and/or another human-machine interface. Furthermore, electronic device 1600 may include a sensor subsystem 1632, which may include one or more types of sensors.

Electronic device 1600 can be (or can be included in) any electronic device with at least one network interface. For example, electronic device 1600 can be (or can be included in): a desktop computer, a laptop computer, a subnotebook/netbook, a server, a supercomputer, a cloud-based computer, a tablet computer, a smartphone, a smartwatch, a cellular telephone, a consumer-electronic device, a portable computing device, communication equipment, a dental drill, a surgical tool or instrument, a handheld tool and/or another electronic device.

Although specific components are used to describe electronic device 1600, in alternative embodiments, different components and/or subsystems may be present in electronic device 1600. For example, electronic device 1600 may include one or more additional processing subsystems, memory subsystems, networking subsystems, and/or display subsystems. Additionally, one or more of the subsystems may not be present in electronic device 1600. Moreover, in some embodiments, electronic device 1600 may include one or more additional subsystems that are not shown in FIG. 16. Also, although separate subsystems are shown in FIG. 16, in some embodiments some or all of a given subsystem or component can be integrated into one or more of the other subsystems or component(s) in electronic device 1600. For example, in some embodiments program instructions 1622 are included in operating system 1624 and/or control logic 1616 is included in interface circuit 1618.

Moreover, the circuits and components in electronic device 1600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1614 and/or electronic device 1600. The integrated circuit may include hardware and/or software mechanisms that are used for transmitting signals from electronic device 1600 and receiving signals at electronic device 1600 from other electronic devices. Aside from the mechanisms herein described, radios are generally known in the art and hence are not described in detail. In general, networking subsystem 1614 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the surgical techniques and/or the training techniques may be implemented using program instructions 1622, operating system 1624 (such as a driver for interface circuit 1618) or in firmware in interface circuit 1618. Thus, the surgical techniques and/or the training techniques may be implemented at runtime of program instructions 1622. Alternatively or additionally, at least some of the operations in the surgical techniques and/or the training techniques may be implemented in a physical layer, such as hardware in interface circuit 1618.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the surgical techniques and/or the training techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a handheld tool, wherein the electronic device is configured to:
receive measurement information associated with the handheld tool during a dental procedure on an individual;
dynamically determine a sequence of operations for creating a dental osteotomy during the dental procedure based at least in part on the measurement information; and
provide information associated with the determined sequence of operations.

2. The electronic device of claim 1, wherein the handheld tool comprises a type of drill.

3. The electronic device of claim 2, wherein the sequence of operations comprises: an electrical draw of a drill motor; a speed of insertion of the drill; a rotation speed of the drill; a torque of the drill; or a rotational energy used to insert an implant into the dental osteometry.

4. The electronic device of claim 1, wherein preparation of the dental osteotomy comprises: drilling into bone; or compressing the bone.

5. The electronic device of claim 1, wherein the measurement information corresponds to resistance of the individual’s bone to cutting or compressing operations during the dental procedure.

6. The electronic device of claim 1, wherein the measurement information comprises a three-dimensional (3D) position of the handheld tool.

7. The electronic device of claim 6, wherein the 3D position is relative to oral anatomy of the individual or to a planned final position of an implant.

8. The electronic device of claim 1, wherein the measurement information corresponds to power consumption as a function of time of the handheld tool during the dental procedure.

9. The electronic device of claim 1, wherein the measurement information corresponds to or comprises: a torque of the handheld tool as a function of time; an electrical current associated with the handheld tool as a function of time; or a position of the handheld tool.

10. The electronic device of claim 1, wherein the determined sequence of operations comprises an output of a pretrained predictive model.

11. The electronic device of claim 10, wherein the pretrained predictive model comprises: a neural network; or a supervised-learning model.

12. The electronic device of claim 1, wherein the information comprises: a depth of the dental osteotomy, a width of the dental osteotomy, or a shape of the dental osteotomy.

13. The electronic device of claim 1, wherein the information comprises a sequence of tools to use during the dental procedure.

14. A non-transitory computer-readable storage medium for use in conjunction with an electronic device, the computer-readable storage medium configured to store program instructions that, when executed by the electronic device, causes the electronic device to perform one or more operations comprising:
receiving measurement information associated with a handheld tool during a dental procedure on an individual;
dynamically determining a sequence of operations for creating a dental osteotomy during the dental procedure based at least in part on the measurement information; and
providing information associated with the determined sequence of operations.

15. The non-transitory computer-readable storage medium of claim 14, wherein the measurement information comprises: a torque of the handheld tool as a function of time; or an electrical current associated with the handheld tool as a function of time.

16. The non-transitory computer-readable storage medium of claim 14, wherein the determined sequence of operations comprises an output of a pretrained predictive model.

17. The non-transitory computer-readable storage medium of claim 14, wherein the measurement information corresponds to resistance of the individual’s bone to cutting or compressing operations during the dental procedure.

18. A method for providing information, comprising:
by an electronic device:
receiving measurement information associated with a handheld tool during a dental procedure on an individual;
dynamically determining a sequence of operations for creating a dental osteotomy during the dental procedure based at least in part on the measurement information; and
providing the information associated with the determined sequence of operations.

19. The method of claim 18, wherein the measurement information comprises: a torque of the handheld tool as a function of time; or an electrical current associated with the handheld tool as a function of time.

20. The method of claim 18, wherein the determined sequence of operations comprises an output of a pretrained predictive model.
